(19) United States
(12) Patent Application Publication
(10) Pub. No.: US 2018/0196364 A1
(43) Pub. Date: Jul. 12, 2018

(54) ELECTROPHOTOGRAPHIC PHOTORECEPTOR, PROCESS CARTRIDGE, AND IMAGE-FORMING APPARATUS

(71) Applicant: FUJI XEROX CO., LTD., Tokyo (JP)

(72) Inventors: Yoshiteru YAMADA, Kanagawa (JP); Keisuke KUSANO, Kanagawa (JP)

(73) Assignee: FUJI XEROX CO., LTD., Tokyo (JP)

(21) Appl. No.: 15/699,008

(22) Filed: Sep. 8, 2017

(30) Foreign Application Priority Data
Jan. 11, 2017 (JP) 2017-002833

(51) Int. Cl. G03G 5/047; G03G 5/147

(52) U.S. Cl. CPC G03G 5/047; G03G 5/0696; G03G 5/14704

(57) ABSTRACT

An electrophotographic photoreceptor includes a conductive base, and a single-layer photosensitive layer disposed on the conductive base and containing a binder resin, a hole transport material, an electron transport material, and a charge generation material. When a gold electrode is provided on the photosensitive layer so as to have an electrode area of 9.3×10⁻¹ cm², and an electric field of 27 V/μm is applied between the gold electrode and the conductive base in an environment at a temperature of 33° C. and a humidity of 80% RH by applying a voltage so that the gold electrode becomes positive, a dark electrical conductivity σ_{d} (1/(Ω·cm)) per unit area is about 4.6×10⁻¹⁴ or less.

### CROSS-REFERENCE TO RELATED APPLICATIONS

This application is based on and claims priority under 35 USC 119 from Japanese Patent Application No. 2017-002833 filed Jan. 11, 2017.

### BACKGROUND

### (i) Technical Field

The present invention relates to an electrophotographic photoreceptor, a process cartridge, and an image-forming apparatus.

### (ii) Related Art

In existing electrophotographic image-forming apparatuses, a toner image formed on a surface of an electrophotographic photoreceptor is transferred to a recording medium through processes of charging, exposure, development, and transfer.

It is known that charge transport materials having enhanced charge transport capabilities are used in photosensitive layers of the electrophotographic photoreceptors used in such electrophotographic image-forming apparatuses.

### SUMMARY

According to an aspect of the invention, there is provided an electrophotographic photoreceptor including a conductive base, and a single-layer photosensitive layer disposed on the conductive base and containing a binder resin, a hole transport material, an electron transport material, and a charge generation material. In the electrophotographic photoreceptor, when a gold electrode is provided on the photosensitive layer so as to have an electrode area of 9.3×10⁻¹ cm², and an electric field of 27 V/μm is applied between the gold electrode and the conductive base in an environment at a temperature of 33° C. and a humidity of 80% RH by applying a voltage so that the gold electrode becomes positive, a dark electrical conductivity σ_{d} (1/(Ω·cm)) per unit area is about 4.6×10⁻¹⁴ or less.

### BRIEF DESCRIPTION OF THE DRAWINGS

Exemplary embodiments of the present invention will be described in detail based on the following figures, wherein:

FIG. 1 is a schematic partial sectional view illustrating an electrophotographic photoreceptor according to an exemplary embodiment;

FIG. 2 is a schematic structural view illustrating an example of an image-forming apparatus according to an exemplary embodiment; and

FIG. 3 is a schematic structural view illustrating an example of an image-forming apparatus according to an exemplary embodiment.

### DETAILED DESCRIPTION

Exemplary embodiments which are examples of the present invention will now be described.

### Electrophotographic Photoreceptor

An electrophotographic photoreceptor (hereinafter, may be referred to as “photoreceptor”) according to an exemplary embodiment includes a conductive base, and a single-layer photosensitive layer disposed on the conductive base and containing a binder resin, a hole transport material, an electron transport material, and a charge generation material. When a gold electrode is provided on the photosensitive layer so as to have an electrode area of 9.3×10⁻¹ cm², and an electric field of 27 V/μm is applied between the gold electrode and the conductive base in an environment at a temperature of 33° C. and a humidity of 80% RH by applying a voltage so that the gold electrode becomes positive, a dark electrical conductivity σ_{d} (1/(Ω·cm)) per unit area is 4.6×10⁻¹⁴ or less or about 4.6×10⁻¹⁴ or less.

Note that the term “single-layer photosensitive layer” refers to a photosensitive layer having a hole-transporting property and an electron-transporting property together with a charge generation capability. In addition, the single-layer photosensitive layer forms an outermost surface of the photoreceptor.

Single-layer photoreceptors have a feature that the number of coating steps is small and the production cost is low compared with photoreceptors including a multilayer photosensitive layer. Therefore, recently, single-layer photoreceptors have attracted attention as, for example, photoreceptors used in low-cost image-forming apparatuses.

However, when an image is repeatedly formed by using such a single-layer photoreceptor in a high-temperature, high-humidity environment (33° C., 80% RH), corrosion may easily occur in a conductive base. When corrosion occurs in the conductive base, a local charge leakage easily occurs in a single-layer photosensitive layer due to the corrosion. Such a local charge leakage may cause the formation of color spots when an image is formed.

In contrast, since the electrophotographic photoreceptor according to the exemplary embodiment has the configuration described above, the formation of color spots in high-temperature, high-humidity environments is suppressed. The reason for this is not clear but is assumed to be as follows.

When a gold electrode is provided on the photosensitive layer so as to have an electrode area of 9.3×10⁻¹ cm², and an electric field of 27 V/μm is applied between the gold electrode and the conductive base in an environment at a temperature of 33° C. and a humidity of 80% RH by applying a voltage so that the gold electrode becomes positive, a dark electrical conductivity σ_{d} (1/(Ω·cm)) per unit area is 4.6×10⁻¹⁴ or less or about 4.6×10⁻¹⁴ or less. As a result, a local charge leakage from the photosensitive layer to the conductive base in a non-photosensitive state is suppressed (leakage resistance is improved), and the injection current injected into the conductive base is optimized. Thus, it is believed that formation of color spots in high-temperature, high-humidity environments will consequently be suppressed.

In addition, a specific hole transport material, a specific electron transport material, and a specific charge generation material are contained in the photosensitive layer, and the specific hole transport material and the specific electron transport material are used in appropriate amounts. As a result, the numerical value range of the dark electrical conductivity in the photosensitive layer is achieved to improve leakage resistance. Thus, it is believed that formation of color spots in high-temperature, high-humidity environments will consequently be suppressed.

An electrophotographic photoreceptor according to the exemplary embodiment will be described in detail with reference to the drawings.

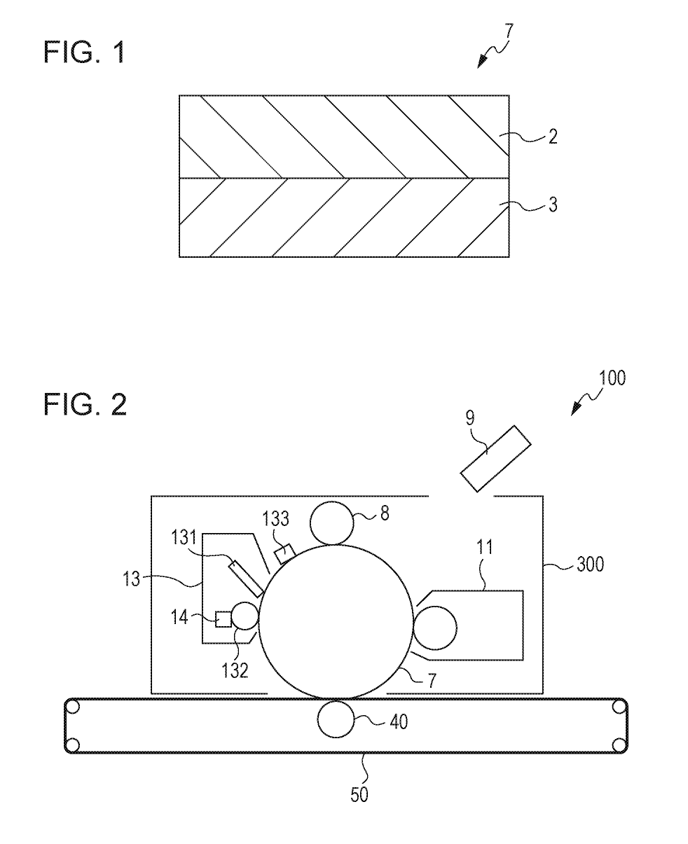

FIG. 1 schematically illustrates a section of a part of an electrophotographic photoreceptor 7 according to the exemplary embodiment.

The electrophotographic photoreceptor 7 illustrated in FIG. 1 includes, for example, a conductive base 3 and a single-layer photosensitive layer 2 disposed directly on the conductive base 3.

The electrophotographic photoreceptor 7 may optionally include, for example, a protective layer on the single-layer photosensitive layer 2.

### Dark Electrical Conductivity σ_{d} of Photosensitive Layer

In the electrophotographic photoreceptor according to the exemplary embodiment, when a gold electrode is provided on the photosensitive layer so as to have an electrode area of 9.3×10⁻¹ cm², and an electric field of 27 V/μm is applied between the gold electrode and a conductive base in an environment at a temperature of 33° C. and a humidity of 80% RH by applying a voltage so that the gold electrode becomes positive, a dark electrical conductivity σ_{d} (1/(Ω·cm)) per unit area is 4.6×10⁻¹⁴ or less or about 4.6×10⁻¹⁴ or less.

When the dark electrical conductivity σ_{d} (1/(Ω·cm)) exceeds 4.6×10⁻¹⁴ or about 4.6×10⁻¹⁴, a large number of color spots are formed in high-temperature, high-humidity environments.

From the viewpoint of suppressing the formation of color spots in high-temperature, high-humidity environments and stability for repeated charging and exposure (cycle stability), the dark electrical conductivity σ_{d} (1/(Ω·cm)) per unit area when an electric field of 27 V/μm is applied is preferably 1.0×10⁻¹⁶ or more and 4.6×10⁻¹⁴ or less or about 1.0×10⁻¹⁶ or more and about 4.6×10⁻¹⁴ or less, more preferably 5.0×10⁻¹⁶ or more and 4.5×10⁻¹⁴ or less, still more preferably 1.0×10⁻¹⁵ or more and 3.0×10⁻¹⁴ or less, and particularly preferably 1.0×10⁻¹⁵ or more and 2.0×10⁻¹⁴ or less or about 1.0×10⁻¹⁵ or more and about 2.0×10⁻¹⁴ or less.

In the electrophotographic photoreceptor according to the exemplary embodiment, when a gold electrode is provided on the photosensitive layer so as to have an electrode area of 9.3×10⁻¹ cm², and an electric field of 10 V/μm is applied between the gold electrode and a conductive base in an environment at a temperature of 33° C. and a humidity of 80% RH by applying a voltage so that the gold electrode becomes positive, the dark electrical conductivity σ_{d} (1/(Ω·cm)) per unit area is preferably 6.0×10⁻¹⁵ or less or about 6.0×10⁻¹⁵ or less, more preferably 1.0×10⁻¹⁷ or more and 6.0×10⁻¹⁵ or less, and still more preferably 5.0×10⁻¹⁷ or more and 4.5×10⁻¹⁵ or less or about 5.0×10⁻¹⁷ or more and about 4.5×10⁻¹⁵ or less. When the dark electrical conductivity σ_{d} is within the above range, the formation of color spots in high-temperature, high-humidity environments is further suppressed and good cycle stability is obtained.

A layer of the electrophotographic photoreceptor according to the exemplary embodiment will be described in detail. Reference numerals are omitted in the description.

### Single-Layer Photosensitive Layer

The single-layer photosensitive layer contains a binder resin, a charge generation material, a hole transport material, and an electron transport material and may optionally contain other additives.

### Electron Transport Material

Examples of the electron transport material used in the exemplary embodiment preferably include compounds represented by formula (ET-1) below and compounds represented by formula (ET-2) below from the viewpoint of suppressing the formation of color spots in high-temperature, high-humidity environments and cycle stability.

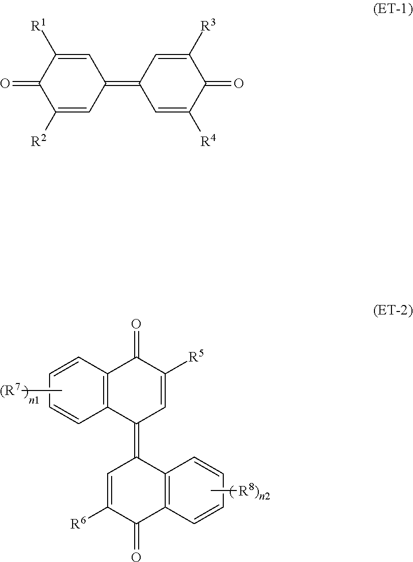

In formulae (ET-1) and (ET-2), R¹ to R⁶ each independently represent an alkyl group, R⁷ and R⁸ each independently represent an alkyl group or a halogen atom, and n1 and n2 each independently represent an integer of from 0 to 4.

From the viewpoint of suppressing the formation of color spots in high-temperature, high-humidity environments and cycle stability, R¹ and R³ are each independently preferably an alkyl group having from 3 to 8 carbon atoms, more preferably a branched alkyl group having from 3 to 8 carbon atoms, still more preferably a branched alkyl group having from 3 to 5 carbon atoms, and particularly preferably a tert-butyl group.

From the viewpoint of suppressing the formation of color spots in high-temperature, high-humidity environments and cycle stability, R¹ and R³ are preferably the same group.

From the viewpoint of suppressing the formation of color spots in high-temperature, high-humidity environments and cycle stability, R² and R⁴ are each independently preferably an alkyl group having from 1 to 8 carbon atoms, more preferably an alkyl group having from 1 to 4 carbon atoms, still more preferably an alkyl group having from 1 to 3 carbon atoms, and particularly preferably a methyl group.

From the viewpoint of suppressing the formation of color spots in high-temperature, high-humidity environments and cycle stability, R² and R⁴ are preferably the same group.

Furthermore, from the viewpoint of suppressing the formation of color spots in high-temperature, high-humidity environments and cycle stability, R¹ and R² are preferably different groups, and R³ and R⁴ are preferably different groups.

From the viewpoint of suppressing the formation of color spots in high-temperature, high-humidity environments and cycle stability, R⁵ and R⁶ are each independently preferably an alkyl group having from 3 to 8 carbon atoms, more preferably a branched alkyl group having from 3 to 8 carbon atoms, still more preferably a branched alkyl group having from 3 to 5 carbon atoms, and particularly preferably a 2-methyl-2-butyl group (—C(CH₃)₂CH₂CH₃).

R⁷ and R⁸ are each independently preferably an alkyl group, a fluorine atom, or a chlorine atom, more preferably an alkyl group having from 1 to 8 carbon atoms or a chlorine atom, and still more preferably a methyl group.

From the viewpoint of suppressing the formation of color spots in high-temperature, high-humidity environments and cycle stability, n1 and n2 are each independently preferably 0 or 1 and more preferably 0.

From the viewpoint of suppressing the formation of color spots in high-temperature, high-humidity environments and cycle stability, the electron transport material used in the exemplary embodiment preferably contains a compound selected from the compound represented by formula (1) below and the compound represented by formula (2) below and is more preferably a compound selected from the compound represented by formula (1) below and the compound represented by formula (2) below.

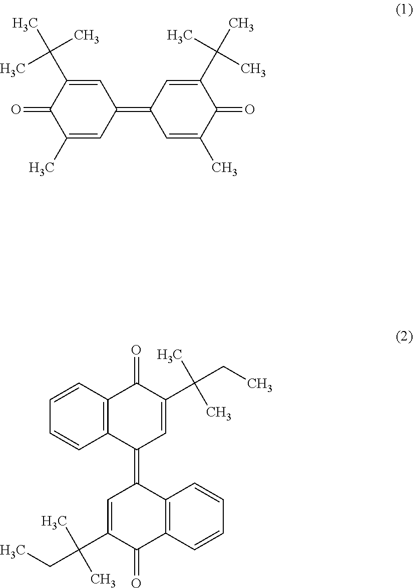 [SMILES: CC1=C/C(=C2\C=C(C)C(=O)C(C(C)(C)C)=C2)C=C(C(C)(C)C)C1=O ; CCC(C)(C)C1=C/C(=C2/C=C(C(C)(C)CC)C(=O)c3ccccc32)c2ccccc2C1=O]

When an electron transport material other than the compound represented by formula (1) or (2) above is contained as the electron transport material, the content of the electron transport material other than the compound represented by formula (1) or (2) is preferably in a range of 10% by weight or less of the total content of the electron transport material.

From the viewpoint of suppressing the formation of color spots in high-temperature, high-humidity environments and cycle stability, the content of the electron transport material in the photosensitive layer is preferably 8% by weight or more and 20% by weight or less or about 8% by weight or more and about 20% by weight or less, more preferably 10% by weight or more and 18% by weight or less, and particularly preferably 12% by weight or more and 16% by weight or less of the total weight of the photosensitive layer.

### Hole Transport Material

From the viewpoint of suppressing the formation of color spots in high-temperature, high-humidity environments and cycle stability, the hole transport material used in the exemplary embodiment preferably contains a compound represented by formula (3) below and is more preferably a compound represented by formula (3) below.

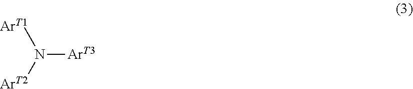

In formula (3), Ar^{T1}, Ar^{T2}, and Ar^{T3} each independently represent an aryl group or —C₆H₄—C(R^{T4})═C(R^{T5})(R^{T6}) where R^{T4}, R^{T5}, and R^{T6} each independently represent a hydrogen atom, an alkyl group, or an aryl group, and R^{T5} and R^{T6} may be bonded to each other to form a hydrocarbon ring.

The aryl groups in Ar^{T1}, Ar^{T2}, Ar^{T3}, R^{T4}, R^{T5}, and R^{T6} may have a substituent on the aromatic ring thereof. Examples of the substituent preferably include halogen atoms, alkyl groups having from 1 to 5 carbon atoms, alkoxy groups having from 1 to 5 carbon atoms, and substituted amino groups substituted with an alkyl group having from 1 to 3 carbon atoms. Examples of the substituent more preferably include halogen atoms and alkyl groups having from 1 to 5 carbon atoms. Examples of the substituent still more preferably include alkyl groups having from 1 to 5 carbon atoms. An example of the substituent is particularly preferably a methyl group.

Examples of the aryl groups in Ar^{T1}, Ar^{T2}, Ar^{T3}, R^{T4}, R^{T5}, and R^{T6} preferably include a phenyl group, a tolyl group, a xylyl group, a chlorophenyl group, alkoxyphenyl groups, and a biphenylyl group.

The alkyl groups in R^{T5} and R^{T6} are each preferably an alkyl group having from 1 to 8 carbon atoms, more preferably an alkyl group having from 1 to 4 carbon atoms, and still more preferably a methyl group or an ethyl group.

From the viewpoint of suppressing the formation of color spots in high-temperature, high-humidity environments and cycle stability, Ar^{T1} and Ar^{T2} are each independently preferably an aryl group, more preferably a phenyl group, a tolyl group, or a xylyl group, still more preferably a phenyl group or a 4-methylphenyl group, and particularly preferably a 4-methylphenyl group.

From the viewpoint of suppressing the formation of color spots in high-temperature, high-humidity environments and cycle stability, Ar^{T1} and Ar^{T2} are preferably the same group.

Ar^{T3} is preferably —C₆H₄—C(R^{T4})═C(R^{T5})(R^{T6}).

R^{T4} is preferably a hydrogen atom, an alkyl group having from 1 to 8 carbon atoms, or a phenyl group and more preferably a hydrogen atom.

From the viewpoint of suppressing the formation of color spots in high-temperature, high-humidity environments and cycle stability, R^{T5} and R^{T6} are each independently preferably an aryl group or are preferably bonded to each other to form a hydrocarbon ring, and are each independently more preferably an aryl group and still more preferably a phenyl group.

Specific examples of the compound represented by formula (3) are shown below. However, the hole transport material used in the exemplary embodiment is not limited to the compounds shown below.

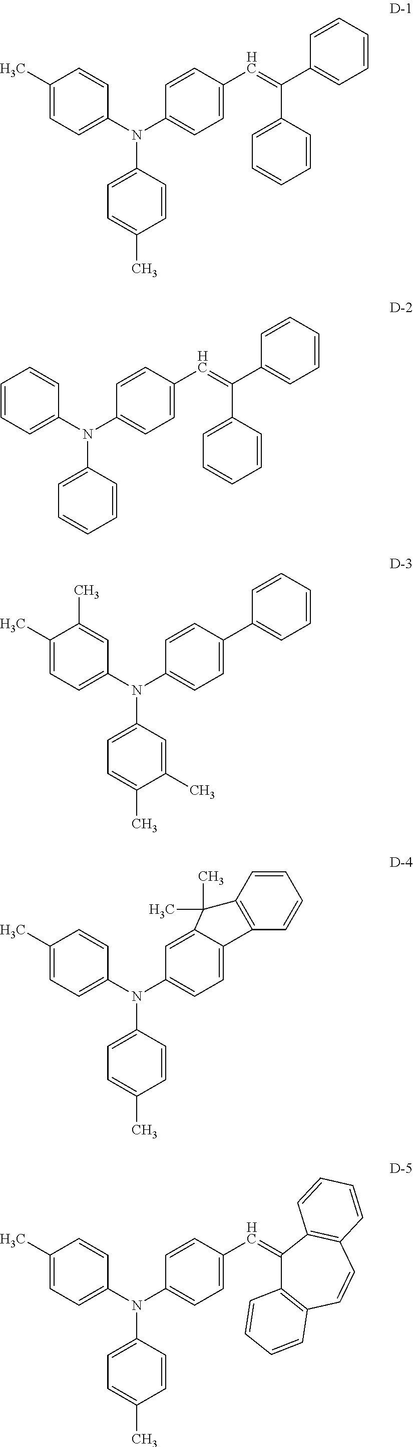 [SMILES: Cc1ccc(N(c2ccc(C)cc2)c2ccc(C=C(c3ccccc3)c3ccccc3)cc2)cc1 ; C(=C(c1ccccc1)c1ccccc1)c1ccc(N(c2ccccc2)c2ccccc2)cc1 ; Cc1ccc(N(c2ccc(-c3ccccc3)cc2)c2ccc(C)c(C)c2)cc1C ; Cc1ccc(N(c2ccc(C)cc2)c2ccc3c(c2)C(C)(C)c2ccccc2-3)cc1 ; Cc1ccc(N(c2ccc(C)cc2)c2ccc(C=C3c4ccccc4C=Cc4ccccc43)cc2)cc1]

Of these, D-1 is preferable as the hole transport material used in the exemplary embodiment.

When a hole transport material other than the compound represented by formula (3) above is contained as the hole transport material, the content of the hole transport material other than the compound represented by formula (3) is preferably in a range of 10% by weight or less of the total content of the hole transport material.

From the viewpoint of suppressing the formation of color spots in high-temperature, high-humidity environments and cycle stability, the content of the hole transport material in the photosensitive layer is preferably 20% by weight or more and 40% by weight or less, more preferably 24% by weight or more and 38% by weight or less, and particularly preferably 28% by weight or more and 36% by weight or less or about 28% by weight or more and about 36% by weight or less of the total weight of the photosensitive layer.

From the viewpoint of suppressing the formation of color spots in high-temperature, high-humidity environments and cycle stability, the total content of the electron transport material and the hole transport material in the photosensitive layer is preferably 36% by weight or more and 56% by weight or less, more preferably 39% by weight or more and 52% by weight or less, and particularly preferably 40% by weight or more and 49% by weight or less of the total weight of the photosensitive layer.

Furthermore, from the viewpoint of suppressing the formation of color spots in high-temperature, high-humidity environments and cycle stability, a ratio of the content W_{E} of the electron transport material to the content W_{H} of the hole transport material in the photosensitive layer is preferably W_{E}:W_{H}=1:1 to 1:5, more preferably W_{E}:W_{H}=1:1.2 to 1:4, and particularly preferably W_{E}:W_{H}=1:1.4 to 1:3.5.

### Charge Generation Material

Examples of the charge generation material include, but are not particularly limited to, azo pigments such as bisazo pigments and trisazo pigments; condensed ring aromatic pigments such as dibromoanthanthrone; perylene pigments; pyrrolopyrrole pigments; phthalocyanine pigments; zinc oxide; and trigonal selenium.

For laser exposure in the near-infrared region, of these, a metal phthalocyanine pigment or a metal-free phthalocyanine pigment may be used as the charge generation material. Specifically, examples thereof include hydroxygallium phthalocyanine, chlorogallium phthalocyanine, dichlorotin phthalocyanine, and titanyl phthalocyanine.

On the other hand, for laser exposure in the near-ultraviolet region, for example, a condensed ring aromatic pigment such as dibromoanthanthrone, a thioindigo pigment, a porphyrazine compound, zinc oxide, trigonal selenium, or a bisazo pigment may be used as the charge generation material.

Specifically, when a light source having an exposure wavelength of, for example, 380 nm or more and 500 nm or less is used, inorganic pigments are preferably used as the charge generation material. When a light source having an exposure wavelength of, for example, 700 nm or more and 800 nm or less is used, metal phthalocyanine pigments and metal-free phthalocyanine pigments are preferably used as the charge generation material.

In particular, at least one selected from hydroxygallium phthalocyanine pigments and chlorogallium phthalocyanine pigments is preferably used as the charge generation material. These charge generation materials may be used alone or as a mixture of two or more thereof. From the viewpoint of increasing the sensitivity of the photoreceptor, hydroxygallium phthalocyanine pigments are preferable.

When a hydroxygallium phthalocyanine pigment and a chlorogallium phthalocyanine pigment are used in combination, a ratio of the hydroxygallium phthalocyanine pigment to the chlorogallium phthalocyanine pigment is preferably, in terms of weight ratio, hydroxygallium phthalocyanine pigment:chlorogallium phthalocyanine pigment=9:1 to 3:7 (more preferably, 9:1 to 6:4).

The hydroxygallium phthalocyanine pigment is not particularly limited but is preferably a type V hydroxygallium phthalocyanine pigment, which will be described later.

In particular, from the viewpoint of obtaining further improved dispersibility, the hydroxygallium phthalocyanine pigment is preferably, for example, a hydroxygallium phthalocyanine pigment having a maximum peak wavelength in the range of 810 nm or more and 839 nm or less in a spectral absorption spectrum in the wavelength range of 600 nm or more and 900 nm or less.

The hydroxygallium phthalocyanine pigment having a maximum peak wavelength in the range of 810 nm or more and 839 nm or less preferably has an average particle size in a specific range and a BET specific surface area in a specific range. Specifically, the average particle size is preferably 0.20 μm or less, and more preferably 0.01 μm or more and 0.15 μm or less. The BET specific surface area is preferably 45 m²/g or more, more preferably 50 m²/g or more, and still more preferably 55 m²/g or more and 120 m²/g or less. The average particle size is a volume-average particle size and is a value measured with a laser diffraction/scattering particle size distribution analyzer (LA-700 available from HORIBA, Ltd.). The BET specific surface area is a value measured by the nitrogen substitution method using a fluid-type specific surface area automatic measuring device (FlowSorb 112300 available from Shimadzu Corporation).

The maximum particle size (maximum of the primary particle size) of the hydroxygallium phthalocyanine pigment is preferably 1.2 μm or less, more preferably 1.0 μm or less, and still more preferably 0.3 μm or less.

The hydroxygallium phthalocyanine pigment preferably has an average particle size of 0.2 μm or less, a maximum particle size of 1.2 μm or less, and a BET specific surface area of 45 m²/g or more.

The hydroxygallium phthalocyanine pigment is preferably a type V hydroxygallium phthalocyanine pigment having diffraction peaks at Bragg angles (2θ±0.2°) of at least 7.3°, 16.0°, 24.9°, and 28.0° in an X-ray diffraction spectrum obtained using a CuKα X-ray.

On the other hand, the chlorogallium phthalocyanine pigment is preferably a compound having diffraction peaks at Bragg angles (2θ±0.2°) of 7.4°, 16.6°, 25.5°, and 28.3° from the viewpoint of the sensitivity of the photosensitive layer. Preferred ranges of the maximum peak wavelength, the average particle size, the maximum particle size, and the BET specific surface area of the chlorogallium phthalocyanine pigment are the same as those of the hydroxygallium phthalocyanine pigment.

The charge generation materials may be used alone or in combination of two or more thereof.

The content of the charge generation material relative to the total solid content of the single-layer photosensitive layer is preferably 1% by weight or more and 5% by weight or less and more preferably 1.2% by weight or more and 4.5% by weight or less.

### Binder Resin

Examples of the binder resin include polycarbonate resins, polyester resins, polyarylate resins, methacrylic resins, acrylic resins, polyvinyl chloride resins, polyvinylidene chloride resins, polystyrene resins, polyvinyl acetate resins, styrene-butadiene copolymers, vinylidene chloride-acrylonitrile copolymers, vinyl chloride-vinyl acetate copolymers, vinyl chloride-vinyl acetate-maleic anhydride copolymers, silicone resins, silicone-alkyd resins, phenol-formaldehyde resins, styrene-alkyd resins, poly-N-vinylcarbazole, and polysilanes. These binder resins may be used alone or as a mixture of two or more thereof.

Among these binder resins, polycarbonate resins and polyarylate resins are preferable from the viewpoint of, for example, mechanical strength of the photosensitive layer.

From the viewpoint of film-formability of the photosensitive layer, at least one of a polycarbonate resin having a viscosity-average molecular weight of 30,000 or more and 80,000 or less and a polyarylate resin having a viscosity-average molecular weight of 30,000 or more and 80,000 or less may be used.

The viscosity-average molecular weight is a value measured by the method described below. One gram of a resin is dissolved in 100 cm³ of methylene chloride, and a specific viscosity ηsp of the resulting solution is measured with an Ubbelohde viscometer in a measurement environment at 25° C. A limiting viscosity [η] (cm³/g) is determined from a formula ηsp/c=[η]+0.45[η]²c (where c represents a concentration (g/cm³)). The viscosity-average molecular weight My is determined from a formula [η]=1.23×10⁻⁴ Mv^{0.83} given by H. Schnell.

The content of the binder resin in the photosensitive layer is preferably 35% by weight or more and 60% by weight or less and more preferably 40% by weight or more and 55% by weight or less of the total weight of the photosensitive layer.

### Other Additives

The single-layer photosensitive layer may contain known additives such as an antioxidant, a light stabilizer, a heat stabilizer, fluororesin particles, and silicone oil.

### Formation of Single-Layer Photosensitive Layer

The single-layer photosensitive layer is formed by using a coating liquid for forming a photosensitive layer, the coating liquid being prepared by adding the above-described components to a solvent.

Examples of the solvent include typical organic solvents such as aromatic hydrocarbons, e.g., benzene, toluene, xylene, and chlorobenzene; ketones, e.g., acetone and 2-butanone; halogenated aliphatic hydrocarbons, e.g., methylene chloride, chloroform, and ethylene chloride; and cyclic or linear ethers, e.g., tetrahydrofuran and ethyl ether. These solvents may be used alone or as a mixture of two or more thereof.

In the method for dispersing particles (for example, the charge generation material) in the coating liquid for forming a photosensitive layer, a media dispersing device such as a ball mill, a vibration ball mill, an attritor, a sand mill, or a horizontal sand mill or a media-less dispersing device such as a stirrer, an ultrasonic dispersing device, a roll mill, or a high-pressure homogenizer is used. Examples of the high-pressure homogenizer include a collision-type homogenizer in which a dispersion is dispersed through liquid-liquid collision or liquid-wall collision under a high pressure, and a penetration-type homogenizer in which a dispersion is dispersed by causing the dispersion to penetrate through a narrow flow path under a high pressure.

Examples of the method for applying the coating liquid for forming a photosensitive layer include a dip coating method, a lift coating method, a wire bar coating method, a spray coating method, a blade coating method, a knife coating method, and a curtain coating method.

The thickness of the single-layer photosensitive layer is determined in the range of preferably 5 μm or more and 60 μm or less, more preferably 5 μm or more and 50 μm or less, and still more preferably 10 μm or more and 40 μm or less.

### Image-Forming Apparatus (and Process Cartridge)

An image-forming apparatus according to an exemplary embodiment includes an electrophotographic photoreceptor, a charging unit that charges a surface of the electrophotographic photoreceptor, an electrostatic latent image forming unit that forms an electrostatic latent image on the charged surface of the electrophotographic photoreceptor, a developing unit that develops the electrostatic latent image formed on the surface of the electrophotographic photoreceptor with a developer containing a toner to form a toner image, and a transfer unit that transfers the toner image onto a surface of a recording medium. The above-described electrophotographic photoreceptor according to the exemplary embodiment is used as the electrophotographic photoreceptor.

Examples of an image-forming apparatus applied to the image-forming apparatus according to the exemplary embodiment include known image-forming apparatuses such as an apparatus including a fixing unit that fixes a toner image transferred to a surface of a recording medium; a direct-transfer-type apparatus that directly transfers a toner image formed on a surface of an electrophotographic photoreceptor onto a recording medium; an intermediate-transfer-type apparatus that transfers a toner image formed on a surface of an electrophotographic photoreceptor onto a surface of an intermediate transfer body (first transfer) and subsequently transfers the toner image on the surface of the intermediate transfer body onto a surface of a recording medium (second transfer); an apparatus including a cleaning unit that cleans a surface of an electrophotographic photoreceptor after transfer of a toner image and before charging; an apparatus including a charge-erasing unit that erases charges by irradiating a surface of an image-carrying member with charge-erasing light after transfer of a toner image and before charging; and an apparatus including an electrophotographic photoreceptor-heating member that increases the temperature of an electrophotographic photoreceptor to decrease the relative temperature.

In the case of the intermediate-transfer-type apparatus, an example of a configuration applied to the transfer unit includes an intermediate transfer body having a surface to which a toner image is transferred, a first transfer unit that transfers a toner image formed on a surface of an image-carrying member to the surface of the intermediate transfer body (first transfer), and a second transfer unit that transfers the toner image transferred to the surface of the intermediate transfer body to a surface of a recording medium (second transfer).

The image-forming apparatus according to the exemplary embodiment may be a dry-development-type image-forming apparatus or a wet-development-type image-forming apparatus (development performed by using a liquid developer).

In the image-forming apparatus according to the exemplary embodiment, a unit including an electrophotographic photoreceptor may have a cartridge structure (process cartridge) that is detachably attachable to the image-forming apparatus. For example, a process cartridge including the electrophotographic photoreceptor according to the exemplary embodiment is suitably used as the process cartridge. The process cartridge may include, in addition to the electrophotographic photoreceptor, for example, at least one selected from a charging unit, an electrostatic latent image forming unit, a developing unit, and a transfer unit.

An example of the image-forming apparatus according to the exemplary embodiment will now be described, but the apparatus is not limited to this example. The portions illustrated in the drawings are described, and the description of the other portions is omitted.

FIG. 2 is a schematic structural view illustrating an example of the image-forming apparatus according to the exemplary embodiment.

As illustrated in FIG. 2, an image-forming apparatus 100 according to the exemplary embodiment includes a process cartridge 300 including an electrophotographic photoreceptor 7, an exposure device 9 (an example of the electrostatic latent image forming unit), a transfer device 40 (first transfer device), and an intermediate transfer body 50. In the image-forming apparatus 100, the exposure device 9 is arranged at a position where the exposure device 9 may apply light to the electrophotographic photoreceptor 7 through an opening in the process cartridge 300. The transfer device 40 is arranged at a position facing the electrophotographic photoreceptor 7 with the intermediate transfer body 50 therebetween. The intermediate transfer body 50 is arranged so that a part of the intermediate transfer body 50 is in contact with the electrophotographic photoreceptor 7. The image-forming apparatus 100 further includes a second transfer device (not shown) that transfers a toner image transferred to the intermediate transfer body 50 to a recording medium (for example, paper). The intermediate transfer body 50, the transfer device 40 (first transfer device), and the second transfer device (not shown) correspond to an example of the transfer unit.

The process cartridge 300 in FIG. 2 integrally supports the electrophotographic photoreceptor 7, a charging device 8 (an example of the charging unit), a developing device 11 (an example of the developing unit), and a cleaning device 13 (an example of the cleaning unit) in a housing. The cleaning device 13 includes a cleaning blade 131 (an example of a cleaning member). The cleaning blade 131 is arranged to come in contact with a surface of the electrophotographic photoreceptor 7. The form of the cleaning member is not limited to the cleaning blade 131. Alternatively, the cleaning member may be a conductive or insulating fibrous member, and the conductive or insulating fibrous member may be used alone or in combination with the cleaning blade 131.

FIG. 2 illustrates an example of an image-forming apparatus including a fibrous member 132 (roll shape) that supplies a lubricant 14 onto the surface of the electrophotographic photoreceptor 7, and a fibrous member 133 (flat brush shape) that assists cleaning. These fibrous members are arranged as required.

Configurations of the image-forming apparatus according to the exemplary embodiment will now be described.

### Charging Device

Examples of the charging device 8 include contact-type chargers that use, for example, conductive or semi-conductive charging rollers, charging brushes, charging films, charging rubber blades, or charging tubes; non-contact-type roller chargers; and known chargers such as scorotron chargers and corotron chargers that use corona discharge.

### Exposure Device

An example of the exposure device 9 is an optical device that illuminates the surface of the electrophotographic photoreceptor 7 with light from a semiconductor laser, an LED, a liquid crystal shutter, or the like so as to form a desired image on the surface. The wavelength of the light source is set to be within the range of the spectral sensitivity of the electrophotographic photoreceptor. Semiconductor lasers that are mainly used are near-infrared lasers having an oscillation wavelength of about 780 nm. However, the wavelength is not limited to this, and a laser having an oscillation wavelength on the order of 600 nm or a blue laser having an oscillation wavelength of 400 nm or more and 450 nm or less may also be used. In order to form color images, a surface-emitting laser light source capable of outputting a multi-beam is also effective.

### Developing Device

An example of the developing device 11 is a typical developing device that performs development by using a developer in a contact or non-contact manner. The developing device 11 is not particularly limited as long as the device has the function described above and is selected in accordance with the purpose. An example thereof is a known developing device having a function of causing a one-component developer or a two-component developer to attach to the electrophotographic photoreceptor 7 with a brush, a roller, or the like. In particular, the developing device may use a developing roller that carries the developer on the surface thereof.

The developer used in the developing device 11 may be a one-component developer containing a toner alone or a two-component developer containing a toner and a carrier. The developer may be magnetic or nonmagnetic. Known developers are used as the developer.

### Cleaning Device

A cleaning blade-type device including the cleaning blade 131 is used as the cleaning device 13.

Besides the cleaning blade-type device, a fur brush cleaning-type device or a device that performs development and cleaning simultaneously may be employed.

### Transfer Device

Examples of the transfer device 40 include contact-type transfer charges that use, for example, belts, rollers, films, or rubber blades, and known transfer chargers such as scorotron transfer chargers and corotron transfer chargers that use corona discharge.

### Intermediate Transfer Body

The intermediate transfer body 50 may be a belt-shaped member (intermediate transfer belt) containing a polyimide, polyamide-imide, a polycarbonate, a polyarylate, a polyester, rubber, or the like that is provided with semiconductivity. The intermediate transfer body may have a drum shape instead of a belt shape.

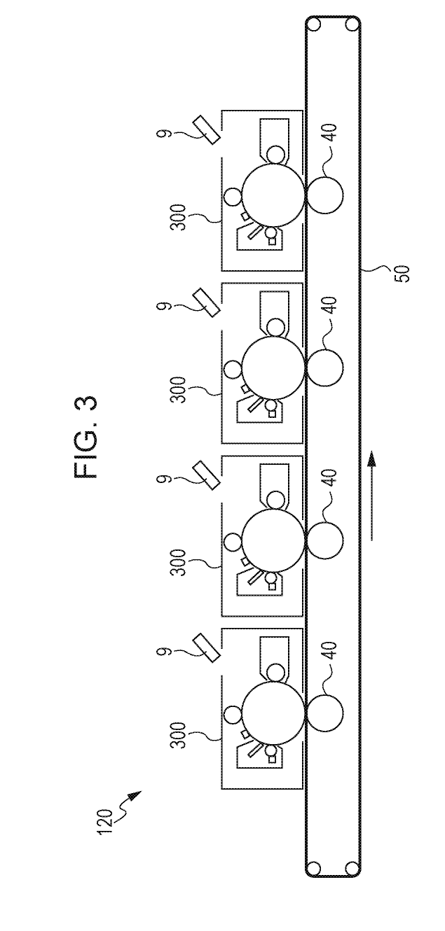

FIG. 3 is a schematic structural view illustrating another example of the image-forming apparatus according to the exemplary embodiment.

An image-forming apparatus 120 illustrated in FIG. 3 is a tandem-type multicolor image-forming apparatus including four process cartridges 300. In the image-forming apparatus 120, the four process cartridges 300 are arranged in parallel on an intermediate transfer body 50, and one electrophotographic photoreceptor is used for one color. The image-forming apparatus 120 has the same configuration as the image-forming apparatus 100 except that the image-forming apparatus 120 is a tandem-type image-forming apparatus.

The configuration of the image-forming apparatus 100 according to the exemplary embodiment is not limited to the configuration described above. For example, a first charge-erasing device that makes the polarity of a residual toner uniform so that the toner is easily removed with a cleaning brush may be provided around the electrophotographic photoreceptor 7 on the downstream side of the transfer device 40 in a direction in which the electrophotographic photoreceptor 7 rotates and on the upstream side of the cleaning device 13 in the direction in which the electrophotographic photoreceptor 7 rotates. Alternatively, a second charge-erasing device that erases charges from the surface of the electrophotographic photoreceptor 7 may be provided on the downstream side of the cleaning device 13 in the direction in which the electrophotographic photoreceptor 7 rotates and on the upstream side of the charging device 8 in the direction in which the electrophotographic photoreceptor 7 rotates.

The configuration of the image-forming apparatus 100 according to the exemplary embodiment is not limited to the configuration described above. A known configuration, for example, a direct-transfer-type image-forming apparatus that directly transfers a toner image formed on the electrophotographic photoreceptor 7 onto a recording medium may be applied to the image-forming apparatus 100.

### EXAMPLES

The exemplary embodiments will now be described specifically by using Examples and Comparative Examples. However, the exemplary embodiments are not limited to the Examples described below.

In the description below, the term “part” refers to part by weight unless otherwise noted.

### Example 1

The charge generation material described in Table 1 in the amount described in Table 1; the electron transport material described in Table 1 in the amount described in Table 1; the hole transport material described in Table 1 in the amount described in Table 1; a bisphenol-Z polycarbonate resin (viscosity-average molecular weight: 45,000) serving as a binder resin in an amount with which the total content of the charge generation material, the electron transport material, the hole transport material, and the binder resin becomes 100 parts by weight; and tetrahydrofuran serving as a solvent in an amount of 250 parts by weight are mixed. The resulting mixture is dispersed for four hours in a sand mill with glass beads having a diameter ϕ of 1 mm. Thus, a coating liquid for forming a photosensitive layer is obtained.

An aluminum base (with a cylindrical shape having a diameter of 30 mm, a length of 244.5 mm, and a wall thickness of 0.7 mm) is prepared. This aluminum base is immersed in a water tank containing water having a pH of 8.1 to wash the aluminum base. The aluminum base removed from the water tank is dried. Subsequently, the coating liquid for forming a photosensitive layer is applied onto the aluminum base by a dip coating method. The applied coating liquid is dried at 135° C. for 20 minutes to form a single-layer photosensitive layer having a thickness of 22 μm. Thus, a photoreceptor is prepared.

### Examples 2 to 16, Comparative Example 1, and Comparative Examples 3 to 17

Photoreceptors are prepared as in Example 1 except that the composition of the components of the photosensitive layer is changed in accordance with Table 1 or 2.

### Comparative Example 2

A photoreceptor is prepared as in Comparative Example 1 except that the drying temperature of the photosensitive layer is changed to 123° C. and the drying time of the photosensitive layer is changed to 24 minutes.

### Evaluations

The photoreceptors of Examples and Comparative Examples are evaluated as described below. Tables 1 and 2 show the results.

Evaluation of Cycle Variability (Change in Potential (AVH) from the First Cycle to the Tenth Cycle)

Each of the photoreceptors prepared above is installed as a photoreceptor of an HL-2360DN printer available from Brother Industries, Ltd. An electrostatic voltmeter probe (Model 555P-1 available from TREK, Inc.) is arranged so as to correctly face a central portion between a charging device of the HL-2360DN printer and an exposure position in an axial direction of the photoreceptor. In a state where this probe is connected to an electrostatic voltmeter (Model 334 available from TREK, Inc.), the photoreceptor is charged using the modified printer by applying a voltage of +600 V to the charging device in an environment at 20° C. and 40% RH, and whole-surface exposure is performed at the exposure position. This cycle of the charging and exposure is repeated, and the surface potential in each cycle is measured up to the tenth cycle.

On the basis of the measurement results, the difference between the surface potential at the tenth cycle and the surface potential at the first cycle is calculated as a change in the surface potential (ΔVH) of the photoreceptor. The ΔVH is evaluated in accordance with the evaluation standards of initial cycle stability described below.

### Evaluation Standards of Initial Cycle Stability

5: ±5 V or less

4: exceeding ±5 V and ±10 V or less

3: exceeding ±10 V and ±15 V or less

2: exceeding ±15 V and ±20 V or less

1: exceeding ±20 V

### Color Spot Evaluation

Regarding the color spot evaluation, a 50% half-tone image is printed by using the HL-2360DN printer available from Brother Industries, Ltd. in an environment at a temperature of 33° C. and a humidity of 80% RH, and color spot defects of the image are evaluated in accordance with the standards described below.

### Evaluation Standards of Color Spots

5: Excellent (No color spot defects)

4: Good (Substantially no color spot defects)

3: Fair (Some color spot defects exist in a range that does not cause a problem)

2: Poor (Color spot defects exist in a range that causes a problem)

1: Bad (Numerous color spot defects exist in a range that causes a problem)

TABLE 1

| | | | | | | | | | Physical properties | | Cycle stability | | |
|---|---|---|---|---|---|---|---|---|---|---|---|---|---|
| | Charge | | Electron | | Hole | | | | 27 V/μm | 10 V/μm | Change in | | |
| | generation | | transport | | transport | | | | Dark | Dark | potential | | Color spot |
| | material | | material | | material | | Resin | | electrical | electrical | from first | Eval- | evaluation |
| | | Parts by | | Parts by | | Parts by | | Parts by | conductivity | conductivity | cycle to | uation | Evaluation |
| Example | Type | weight | Type | weight | Type | weight | Type | weight | (1/(Ω · cm)) | (1/(Ω · cm)) | tenth cycle | result | result |
| Example 1 | Pigment 2 | 1.0 | (A)-1 | 14 | D-1 | 28 | PCZ | 57 | 1.67 × 10⁻¹⁴ | 3.39 × 10⁻¹⁵ | (−)4.0 V | 5 | 5 |
| Example 2 | Pigment 2 | 1.0 | (A)-2 | 14 | D-1 | 28 | PCZ | 57 | 1.63 × 10⁻¹⁴ | 3.59 × 10⁻¹⁵ | 2.1 V | 5 | 5 |
| Example 3 | Pigment 1/ | 1.5 | (A)-1 | 14 | D-1 | 28 | PCZ | 56.5 | 2.54 × 10⁻¹⁴ | 3.55 × 10⁻¹⁵ | (−)8.3 V | 4 | 5 |
| | Pigment 2 | | | | | | | | | | | | |
| Example 4 | Pigment 1/ | 1.5 | (A)-2 | 14 | D-1 | 28 | PCZ | 56.5 | 2.59 × 10⁻¹⁴ | 3.69 × 10⁻¹⁵ | 5.1 V | 4 | 5 |
| | Pigment 2 | | | | | | | | | | | | |
| Example 5 | Pigment 2 | 1.0 | (A)-1 | 20 | D-1 | 28 | PCZ | 51 | 4.44 × 10⁻¹⁴ | 5.83 × 10⁻¹⁵ | 9.8 V | 4 | 4 |
| Example 6 | Pigment 2 | 1.0 | (A)-1 | 8 | D-1 | 36 | PCZ | 55 | 3.91 × 10⁻¹⁴ | 5.61 × 10⁻¹⁵ | 8.2 V | 4 | 5 |
| Example 7 | Pigment 2 | 1.0 | (A)-1 | 10 | D-1 | 36 | PCZ | 53 | 3.99 × 10⁻¹⁴ | 5.76 × 10⁻¹⁵ | 9.3 V | 4 | 5 |
| Example 8 | Pigment 2 | 1.0 | (A)-1 | 18 | D-1 | 26 | PCZ | 55 | 3.20 × 10⁻¹⁴ | 4.80 × 10⁻¹⁵ | 9.6 V | 4 | 4 |
| Example 9 | Pigment 2 | 1.0 | (A)-2 | 20 | D-1 | 28 | PCZ | 51 | 4.58 × 10⁻¹⁴ | 5.97 × 10⁻¹⁵ | 9.9 V | 4 | 4 |
| Example 10 | Pigment 2 | 1.0 | (A)-2 | 8 | D-1 | 36 | PCZ | 55 | 4.00 × 10⁻¹⁴ | 5.66 × 10⁻¹⁵ | 8.8 V | 4 | 5 |
| Example 11 | Pigment 2 | 1.0 | (A)-2 | 10 | D-1 | 36 | PCZ | 53 | 4.43 × 10⁻¹⁴ | 5.75 × 10⁻¹⁵ | 9.6 V | 4 | 5 |
| Example 12 | Pigment 2 | 1.0 | (A)-2 | 18 | D-1 | 26 | PCZ | 55 | 4.18 × 10⁻¹⁴ | 5.63 × 10⁻¹⁵ | 9.9 V | 4 | 4 |
| Example 13 | Pigment 2 | 1.0 | (G) | 14 | D-1 | 28 | PCZ | 57 | 4.31 × 10⁻¹⁴ | 4.33 × 10⁻¹⁵ | (−)8.2 V | 4 | 4 |
| Example 14 | Pigment 2 | 1.0 | (A)-1 | 14 | D-2 | 28 | PCZ | 57 | 2.89 × 10⁻¹⁴ | 3.77 × 10⁻¹⁵ | (−)4.3 V | 5 | 5 |
| Example 15 | Pigment 2 | 1.0 | (A)-1 | 14 | D-3 | 28 | PCZ | 57 | 3.01 × 10⁻¹⁴ | 3.99 × 10⁻¹⁵ | (−)5.0 V | 4 | 5 |
| Example 16 | Pigment 1 | 1.5 | (A)-1 | 14 | D-1 | 28 | PCZ | 56.5 | 3.36 × 10⁻¹⁴ | 3.75 × 10⁻¹⁵ | (−)9.1 V | 4 | 5 |

TABLE 2

| | Charge generation | | Electron | | Hole transport | | | |
|---|---|---|---|---|---|---|---|---|
| | material | | transport | | material | | Resin | |
| | | Parts | material | | | Parts | | Parts |
| | | by | | Parts by | | by | | by |
| Example | Type | weight | Type | weight | Type | weight | Type | weight |
| Com. Ex. 1 | Pigment 1/Pigment 2 | 1.5 | (B) | 8 | D-1 | 36 | PCZ | 54.5 |
| Com. Ex. 2 | Pigment 1/Pigment 2 | 1.5 | (B) | 8 | D-1 | 36 | PCZ | 54.5 |
| Com. Ex. 3 | Pigment 1/Pigment 2 | 1.5 | (B) | 14 | D-1/D-C1 | 40 | PCZ | 44.5 |
| Com. Ex. 4 | TiOPc (Type i) | 1.5 | (B) | 8 | D-1 | 36 | PCZ | 54.5 |
| Com. Ex. 5 | Pigment 1/Pigment 2 | 1.5 | (C) | 8 | D-1 | 36 | PCZ | 54.5 |
| Com. Ex. 6 | Pigment 1/Pigment 2 | 1.5 | (C) | 8 | D-1/D-C1 | 36 | PCZ | 54.5 |
| Com. Ex. 7 | Pigment 2 | 1.0 | (A)-1 | 22 | D-1 | 38 | PCZ | 39 |
| Com. Ex. 8 | Pigment 2 | 1.0 | (A)-1 | 6 | D-1 | 32 | PCZ | 61 |
| Com. Ex. 9 | Pigment 2 | 1.0 | (A)-1 | 12 | D-1 | 26 | PCZ | 61 |
| Com. Ex. 10 | Pigment 2 | 1.0 | (A)-1 | 18 | D-1 | 38 | PCZ | 43 |
| Com. Ex. 11 | Pigment 2 | 1.0 | (A)-2 | 22 | D-1 | 38 | PCZ | 39 |
| Com. Ex. 12 | Pigment 2 | 1.0 | (A)-2 | 6 | D-1 | 32 | PCZ | 61 |
| Com. Ex. 13 | Pigment 2 | 1.0 | (A)-2 | 12 | D-1 | 26 | PCZ | 61 |
| Com. Ex. 14 | Pigment 2 | 1.0 | (A)-2 | 18 | D-1 | 38 | PCZ | 43 |
| Com. Ex. 15 | TiOPc (Type i) | 1.0 | (D) | 14 | D-1 | 32 | PCZ | 53 |
| Com. Ex. 16 | TiOPc (Type Y) | 1.0 | (E)/(F) | 19 | D-D | 40 | BP26Z74 | 40 |
| Com. Ex. 17 | Pigment 1 | 1.5 | (B) | 8 | D-1 | 36 | PCZ | 54.5 |

| | Physical properties | | Cycle stability | | |
|---|---|---|---|---|---|
| | 27 V/μm | 10 V/μm | Change in | | |
| | Dark | Dark | potential | | Color spot |
| | electrical | electrical | from first | | evaluation |
| | conductivity | conductivity | cycle to | Evaluation | Evaluation |
| Example | (1/(Ω · cm)) | (1/(Ω · cm)) | tenth cycle | result | result |
| Com. Ex. 1 | 1.39 × 10⁻¹³ | 9.03 × 10⁻¹⁵ | 24 V | 1 | 3 |
| Com. Ex. 2 | 7.03 × 10⁻¹⁴ | 6.34 × 10⁻¹⁵ | 24 V | 1 | 3 |
| Com. Ex. 3 | 1.53 × 10⁻¹² | 7.04 × 10⁻¹⁵ | 34 V | 1 | 1 |
| Com. Ex. 4 | 1.53 × 10⁻¹³ | 1.05 × 10⁻¹⁴ | 30.3 V | 1 | 3 |
| Com. Ex. 5 | 3.43 × 10⁻¹² | 2.21 × 10⁻¹⁵ | 28.5 V | 1 | 2 |
| Com. Ex. 6 | 5.61 × 10⁻¹² | 9.55 × 10⁻¹⁵ | 32.3 V | 1 | 2 |
| Com. Ex. 7 | 9.06 × 10⁻¹⁴ | 6.66 × 10⁻¹⁵ | 13.7 V | 3 | 3 |
| Com. Ex. 8 | 4.90 × 10⁻¹⁴ | 6.03 × 10⁻¹⁵ | 14.1 V | 3 | 3 |
| Com. Ex. 9 | 4.65 × 10⁻¹⁴ | 6.15 × 10⁻¹⁵ | 10.5 V | 3 | 3 |
| Com. Ex. 10 | 6.79 × 10⁻¹⁴ | 6.66 × 10⁻¹⁵ | 16.1 V | 2 | 3 |
| Com. Ex. 11 | 1.25 × 10⁻¹³ | 8.95 × 10⁻¹⁵ | 26.4 V | 1 | 3 |
| Com. Ex. 12 | 5.54 × 10⁻¹⁴ | 7.18 × 10⁻¹⁵ | 15.1 V | 2 | 3 |
| Com. Ex. 13 | 4.87 × 10⁻¹⁴ | 6.33 × 10⁻¹⁵ | 11.5 V | 3 | 3 |
| Com. Ex. 14 | 7.51 × 10⁻¹⁴ | 7.02 × 10⁻¹⁵ | 38.9 V | 1 | 3 |
| Com. Ex. 15 | 4.30 × 10⁻¹³ | 3.74 × 10⁻¹⁴ | (−)19 V | 2 | 3 |
| Com. Ex. 16 | 3.43 × 10⁻¹³ | 2.71 × 10⁻¹⁴ | (−)11.6 V | 3 | 3 |
| Com. Ex. 17 | 1.59 × 10⁻¹³ | 8.43 × 10⁻¹⁵ | 27 V | 4 | 3 |

Com. Ex.: Comparative Example

In Tables 1 and 2, the expression “Pigment 1/Pigment 2” in the charge generation material means that Pigment 1 and Pigment 2 are used in combination, and the content ratio is Pigment 1:Pigment 2=3.5:6.5 (weight ratio). In addition, the pigments are used such that the total amount thereof becomes the amount described in Table 1 or 2. In Table 2, the expression “(E)/(F)” in the electron transport material means that (E) and (F) are used in combination, and the content ratio is (E):(F)=2:17 (weight ratio). In addition, the electron transport materials are used such that the total amount thereof becomes the amount described in Table 2. In Table 2, the expression “D-1/D-C1” in the hole transport material means that D-1 and D-C1 are used in combination, and the content ratio is D-1:D-C1=2:3 (weight ratio). In addition, the hole transport materials are used such that the total amount thereof becomes the amount described in Table 2.

Details of abbreviations etc. in Tables 1 and 2 are as follows.

### Charge Generation Material

Pigment 1: Type V Hydroxygallium Phthalocyanine Pigment

The Type V hydroxygallium phthalocyanine pigment has diffraction peaks at Bragg angles (2θ±0.2°) of at least 7.3°, 16.0°, 24.9°, and 28.0° in an X-ray diffraction spectrum obtained using a CuKα X-ray. Maximum peak wavelength in a spectral absorption spectrum in a wavelength range of from 600 to 900 nm: 820 nm, Average particle size: 0.12 μm, Maximum particle size: 0.2 μm, BET specific surface area: 60 m²/g

Pigment 2: Chlorogallium Phthalocyanine Pigment

The chlorogallium phthalocyanine pigment has diffraction peaks at Bragg angles (2θ±0.2°) of at least 7.4°, 16.6°, 25.5°, and 28.3° in an X-ray diffraction spectrum obtained using a CuKα X-ray. Maximum peak wavelength in a spectral absorption spectrum in a wavelength range of from 600 to 900 nm: 780 nm, Average particle size: 0.15 μm, Maximum particle size: 0.2 μm, BET specific surface area: 56 m²/g

TiOPc (Type i): Type i Titanyl Phthalocyanine

The type i titanyl phthalocyanine has diffraction peaks at Bragg angles (2θ±0.2°) of at least 9.0°, 14.2°, 23.9°, and 27.1° in an X-ray diffraction spectrum obtained using a CuKα X-ray.

TiOPc (Type Y): Type Y Titanyl Phthalocyanine

The type Y titanyl phthalocyanine has diffraction peaks at Bragg angles (2θ±0.2°) of at least 9.6° and 27.3° in an X-ray diffraction spectrum obtained using a CuKα X-ray.

### Electron Transport Material

(A)-1: Compound represented by formula (1) above

(A)-2: Compound represented by formula (2) above

(B): Compound shown below

(C): Compound shown below

(D): Compound shown below

(E): Compound shown below

(F): Compound shown below

(G): Compound shown below

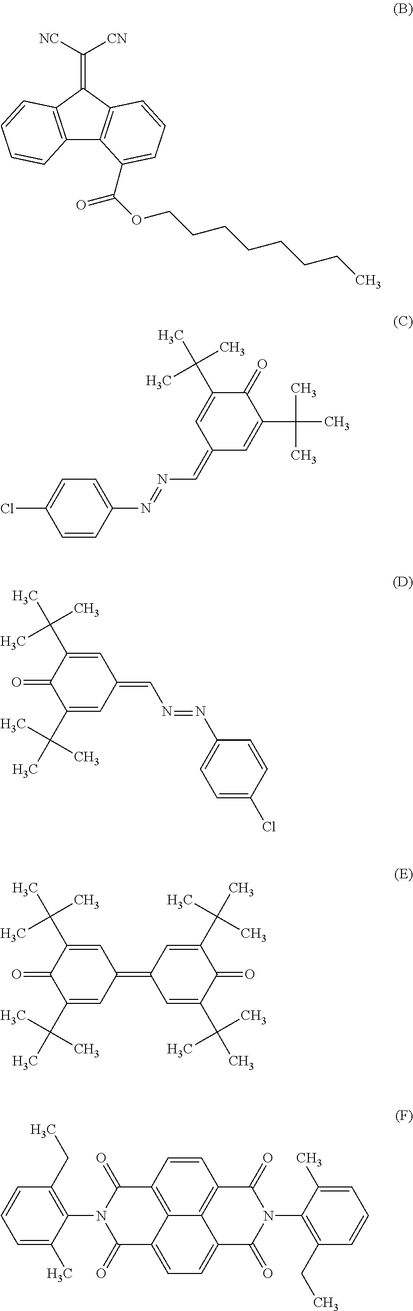 [SMILES: CCCCCCCCOC(=O)c1cccc2c1-c1ccccc1C2=C(C#N)C#N ; CC(C)(C)C1=CC(=C/N=N/c2ccc(Cl)cc2)C=C(C(C)(C)C)C1=O ; CC(C)(C)C1=CC(=C/N=N/c2ccc(Cl)cc2)C=C(C(C)(C)C)C1=O ; CC(C)(C)C1=CC(=C2C=C(C(C)(C)C)C(=O)C(C(C)(C)C)=C2)C=C(C(C)(C)C)C1=O ; CCc1cccc(C)c1N1C(=O)c2ccc3c4c(ccc(c24)C1=O)C(=O)N(c1c(C)cccc1CC)C3=O]

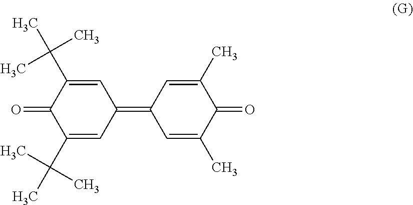 [SMILES: CC1=CC(=C2C=C(C(C)(C)C)C(=O)C(C(C)(C)C)=C2)C=C(C)C1=O]

Hole Transport Material
D-1: Compound shown below (Compound the same as D-1 above)
D-2: Compound shown below (Compound the same as D-2 above)
D-3: Compound shown below (Compound the same as D-3 above)
D-C1: Compound shown below
D-D: Compound shown below

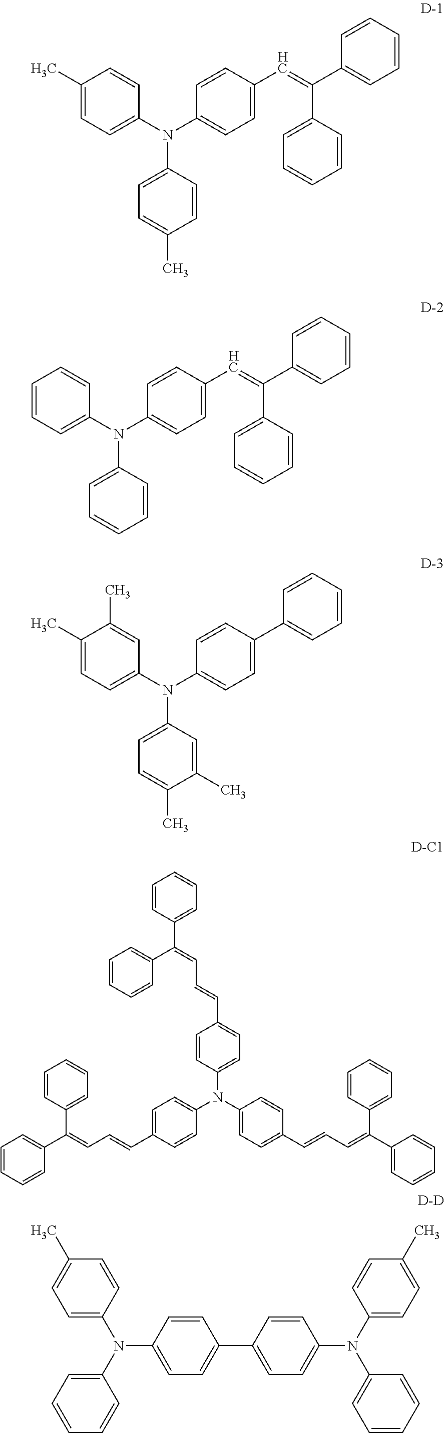

Resin
PCZ: Bisphenol-Z polycarbonate resin (viscosity-average molecular weight: 45,000)
BP26Z74: Compound shown below, ratio m/n=26/74, Mw=81,000

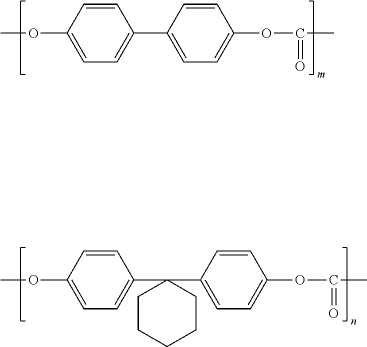

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrophotographic photoreceptor comprising:
a conductive base; and
a single-layer photosensitive layer disposed on the conductive base and containing a binder resin, a hole transport material, an electron transport material, and a charge generation material,
wherein when a gold electrode is provided on the photosensitive layer so as to have an electrode area of 9.3×10⁻¹ cm², and an electric field of 27 V/μm is applied between the gold electrode and the conductive base in an environment at a temperature of 33° C. and a humidity of 80% RH by applying a voltage so that the gold electrode becomes positive, a dark electrical conductivity σ_{d} (1/(Ω·cm)) per unit area is about 4.6×10⁻¹⁴ or less.

2. The electrophotographic photoreceptor according to claim 1, wherein when a gold electrode is provided on the photosensitive layer so as to have an electrode area of 9.3×10⁻¹ cm², and an electric field of 27 V/μm is applied between the gold electrode and the conductive base in an environment at a temperature of 33° C. and a humidity of 80% RH by applying a voltage so that the gold electrode becomes positive, the dark electrical conductivity σ_{d} (1/(Ω·cm)) per unit area is about 1.0×10⁻¹⁵ or more and about 2.0×10⁻¹⁴ or less.

3. The electrophotographic photoreceptor according to claim 1, wherein when a gold electrode is provided on the photosensitive layer so as to have an electrode area of 9.3×10⁻¹ cm², and an electric field of 10 V/μm is applied between the gold electrode and the conductive base in an environment at a temperature of 33° C. and a humidity of 80% RH by applying a voltage so that the gold electrode becomes positive, a dark electrical conductivity σ_{d} (1/(Ω·cm)) per unit area is about 6.0×10⁻¹⁵ or less.

4. The electrophotographic photoreceptor according to claim 3, wherein when a gold electrode is provided on the photosensitive layer so as to have an electrode area of 9.3×10⁻¹ cm², and an electric field of 10 V/μm is applied between the gold electrode and the conductive base in an environment at a temperature of 33° C. and a humidity of 80% RH by applying a voltage so that the gold electrode becomes positive, the dark electrical conductivity σ_{d} (1/(Ω·cm)) per unit area is about 5.0×10⁻¹⁷ or more and about 4.5×10⁻¹⁵ or less.

5. The electrophotographic photoreceptor according to claim 1, wherein the electron transport material contains a compound selected from the group consisting of compounds represented by formula (ET-1) and compounds represented by formula (ET-2): 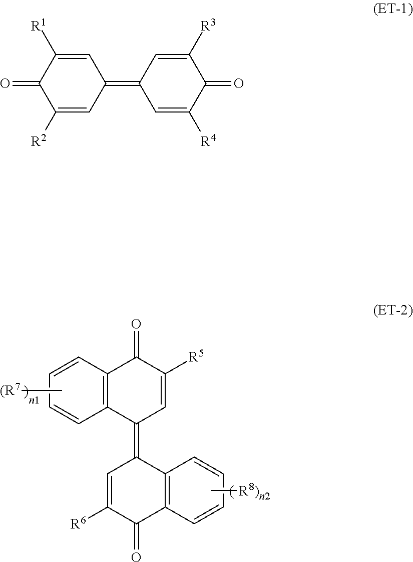
where R¹ to R⁶ each independently represent an alkyl group, R⁷ and R⁸ each independently represent an alkyl group or a halogen atom, and n1 and n2 each independently represent an integer of from 0 to 4.

6. The electrophotographic photoreceptor according to claim 5, wherein R¹ and R³ are each independently an alkyl group having from 3 to 8 carbon atoms.

7. The electrophotographic photoreceptor according to claim 6, wherein R¹ and R³ are each independently a branched alkyl group having from 3 to 8 carbon atoms.

8. The electrophotographic photoreceptor according to claim 5, wherein R² and R⁴ are each independently an alkyl group having from 1 to 8 carbon atoms.

9. The electrophotographic photoreceptor according to claim 5, wherein R⁵ and R⁶ are each independently an alkyl group having from 3 to 8 carbon atoms.

10. The electrophotographic photoreceptor according to claim 9, wherein R⁵ and R⁶ are each independently a branched alkyl group having from 3 to 8 carbon atoms.

11. The electrophotographic photoreceptor according to claim 1, wherein the electron transport material contains a compound selected from the group consisting of a compound represented by formula (1) and a compound represented by formula (2).

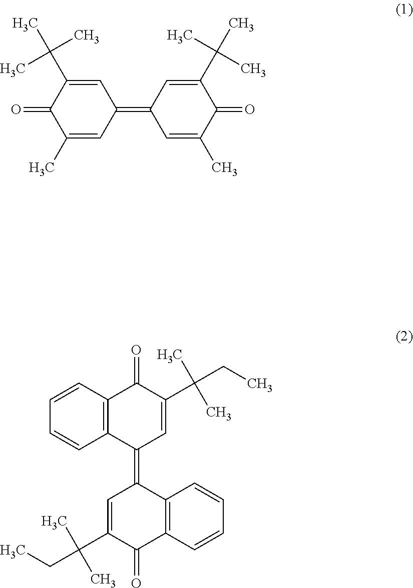 [SMILES: CC1=C/C(=C2\C=C(C)C(=O)C(C(C)(C)C)=C2)C=C(C(C)(C)C)C1=O ; CCC(C)(C)C1=C/C(=C2/C=C(C(C)(C)CC)C(=O)c3ccccc32)c2ccccc2C1=O]

12. The electrophotographic photoreceptor according to claim 1, wherein a content of the electron transport material is about 8% by weight or more and about 20% by weight or less of the total weight of the photosensitive layer.

13. The electrophotographic photoreceptor according to claim 1, wherein the hole transport material contains a compound represented by formula (3): 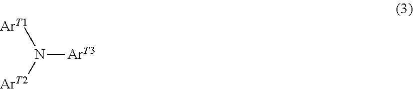
where Ar^{T1}, Ar^{T2}, and Ar^{T3} each independently represent an aryl group or —C₆H₄—C(R^{T4})═C(R^{T5})(R^{T6}) where R^{T4}, R^{T5}, and R^{T6} each independently represent a hydrogen atom, an alkyl group, or an aryl group, and R^{T5} and R^{T6} may be bonded to each other to form a hydrocarbon ring.

14. The electrophotographic photoreceptor according to claim 1, wherein a content of the hole transport material is about 28% by weight or more and about 36% by weight or less of the total weight of the photosensitive layer.

15. The electrophotographic photoreceptor according to claim 1, wherein the charge generation material contains at least one compound selected from the group consisting of hydroxygallium phthalocyanine pigments and chlorogallium phthalocyanine pigments.

16. The electrophotographic photoreceptor according to claim 15, wherein the charge generation material contains a type V hydroxygallium phthalocyanine pigment.

17. A process cartridge comprising:
the electrophotographic photoreceptor according to claim 1,
wherein the process cartridge is detachably attachable to an image-forming apparatus.

18. An image-forming apparatus comprising:
the electrophotographic photoreceptor according to claim 1;
a charging unit that charges a surface of the electrophotographic photoreceptor;
an electrostatic latent image forming unit that forms an electrostatic latent image on the charged surface of the electrophotographic photoreceptor;
a developing unit that develops the electrostatic latent image formed on the surface of the electrophotographic photoreceptor with a developer containing a toner to form a toner image; and
a transfer unit that transfers the toner image onto a surface of a recording medium.
